(19) United States
(12) Patent Application Publication
(10) Pub. No.: US 2004/0094590 A1
(43) Pub. Date: May 20, 2004

(54) Child's toy caddy

(76) Inventor: Michael F. Hollick, (US)

Correspondence Address: D.W. EGGINS, 18 DOWNSVIEW DRIVE, BARRIE, ON, L4M 4P8, CA

(21) Appl. No.: 10/714,974

(22) Filed: Nov. 18, 2003

Related U.S. Application Data
(63) Continuation-in-part of application No. 10/050,713, filed on Jan. 18, 2002.

(51) Int. Cl. B62J 7/06; B62J 7/00; B62J 9/00; B62J 11/00

(52) U.S. Cl. 224/420; 224/425

(57) ABSTRACT

A child's toy caddy for use with a conveyance such as a bicycle, tricycle, or scooter, has a miniscule seat some five inches wide by four inches deep, to bar use by humans. It has a pair of handles permitting drop-on attachment to the handlebars of the conveyance, so that a child's toy such as a doll, teddy bear, raptor or like favoured toy can be strapped into the seat of the caddy, and safely transported by the child while at play with the conveyance. The caddy includes a seat pommel and safety harness with safety belt and shoulder strap, enabling a child to secure its toy to the caddy, with safe transportation for the toy, and safe use by the child of the conveyance. The caddy handles are sized to readily accommodate the brake cables of a bicycle. The caddy can be used with other environments such as a fence or seat-back, solely to accommodate a toy.

### CROSS REFERENCE TO RELATED APPLICATIONS

This Application is a Continuation-in-Part of application Ser. No. 10/050,713 filed Jan. 18, 2002.

### STATEMENT REGARDING FEDERALLY SPONSORED RESEARCH OR DEVELOPMENT

Not Applicable

### REFERENCE TO MICROFICHE APPENDIX

Not Applicable

### BACKGROUND OF THE INVENTION

1. This invention is directed to a toy caddy for use by a child in the safe transportation of a child's toy, and in particular to a toy caddy to be used when playing on a scooter or bicycle, for mounting upon the handlebars of the scooter or bicycle.

2. The use of a conveyance seat in combination with a bicycle is very old, as witnessed in U.S. Pat. No. 416,699 Whitman Dec. 3, 1889;

U.S. Pat. No. 450,712 Voss April 21, 1891;

U.S. Pat. No. 556,951 Williams et al Mar. 24, 1896.

In order to avoid any reasonable possibility of the subject Child's Toy Caddy being used with humans, the seat area is miniscule, being but five inches wide and four inches deep, so that its use by a human is virtually impossible.

In my earlier invention, U.S. Pat. No. 5,921,844, I provided a child's plaything consisting of a wheeled toy that could be trundled along by a child, the toy having a seat structure in which a soft toy such as a doll or a teddy bear could be safely strapped. This earlier plaything has the limitation that the active utilization of the seat and associated toy is dependent upon use with the trundle plaything with which the seat is combined, and with the child being prepared to trundle the toy along.

### BRIEF SUMMARY OF THE INVENTION

The present invention provides a toy caddy for use with a conveyance such as a bicycle, tricycle, or scooter, the caddy having a pair of handles permitting drop-on attachment to the handlebars of the conveyance, so that a child's toy such as a doll, teddy bear, raptor or like favoured toy can be strapped into the seat of the caddy, and safely transported by the child while at play with the conveyance.

The toy caddy also teaches safety principles in that it includes a safety harness consisting of a safety belt and a shoulder strap, by means of which a child can secure its toy into the toy caddy, for transportation upon a conveyance with safety for both the toy and for the child. The seat of the caddy incorporates an upstanding pommel located centrally of the front edge of the seat. The toy is place downwardly upon the seat of the caddy so that the pommel extend upwardly between the legs of the toy, in the fashion of the pommel of a riding saddle, to prevent forward sliding of the toy from beneath the lap strap of the safety harness.

The handles of the caddy may be made with a degree of flexibility such that the imposition of an undue load, such as a child attempting to sit upon the caddy, will result in release of the caddy from off the supporting handlebars. Such mis-use is thwarted by the miniscule size of the seat of the caddy, some five inches wide by four inches deep.

The handles of the caddy are sized to readily accommodate the brake cables of a bicycle. The toy caddy may also be mounted upon a structure such as a fence, and in some instances, upon the back of a car seat. In embodiments having laterally flexible handle portions, the lateral flexibility may greatly facilitate such usage with a car seat.

It is contemplated that two such handles may be curved together, to provide a single attachment point.

### BRIEF DESCRIPTION OF THE SEVERAL VIEWS OF THE DRAWINGS

Certain embodiments of the invention are described by way of illustration, without limitation thereto other than as set forth in the accompanying claims, reference being made to the accompanying drawings, wherein:

FIG. 1 a perspective view of a toy caddy in accordance with the present invention, mounted upon the handlebars of a scooter;

FIG. 2 is a side elevation of another embodiment of the subject toy caddy, mounted upon the handlebars of a bicycle; and,

FIG. 3 is a front perspective view from above of the FIG. 2 caddy embodiment.

### DETAILED DESCRIPTION OF THE INVENTION

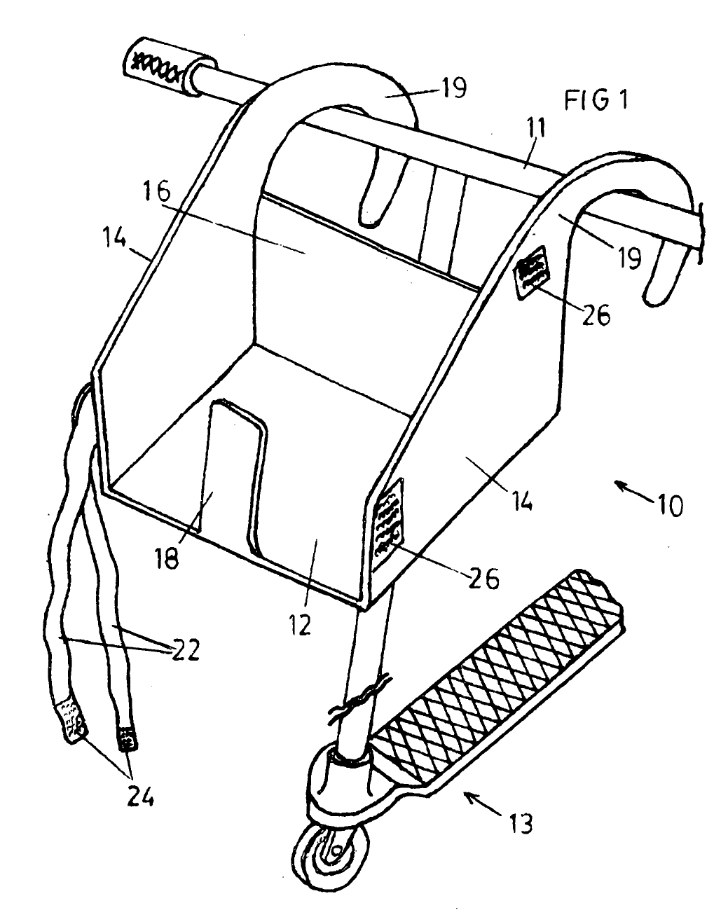

Referring to FIG. 1, the toy caddy 10, is shown mounted upon the handlebars 111 of a scooter 13, of which only the front portion is shown.

The toy caddy consists of a seat portion 12, having sides 14 and a back 16.

The dimensions of the seat portion 12 are such as to substantially preclude the occupancy of the seat 12 by a human.

A pommel 18 projects upwardly from the front-center of the seat portion 12, for entry between the legs of a toy, in motion-restraining relation.

Curved handle portions 19, illustrated with a deep, thin section, support the caddy 10. Safety straps 22 secured to one side 14 of the caddy have hooked pads 24 of the Velcro (T.M.) type at their ends. Felt pads 26 located on the other side 14 of the caddy receive the pads 24 in detachably secured relation therewith, so that the safety straps 22 form a lap strap and a shoulder strap respectively for a toy (not shown) when seated in the caddy.

The combined restraint afforded by the pommel 18 and the harness of straps 22 substantially precludes displacement of a toy, when properly secured in the toy caddy.

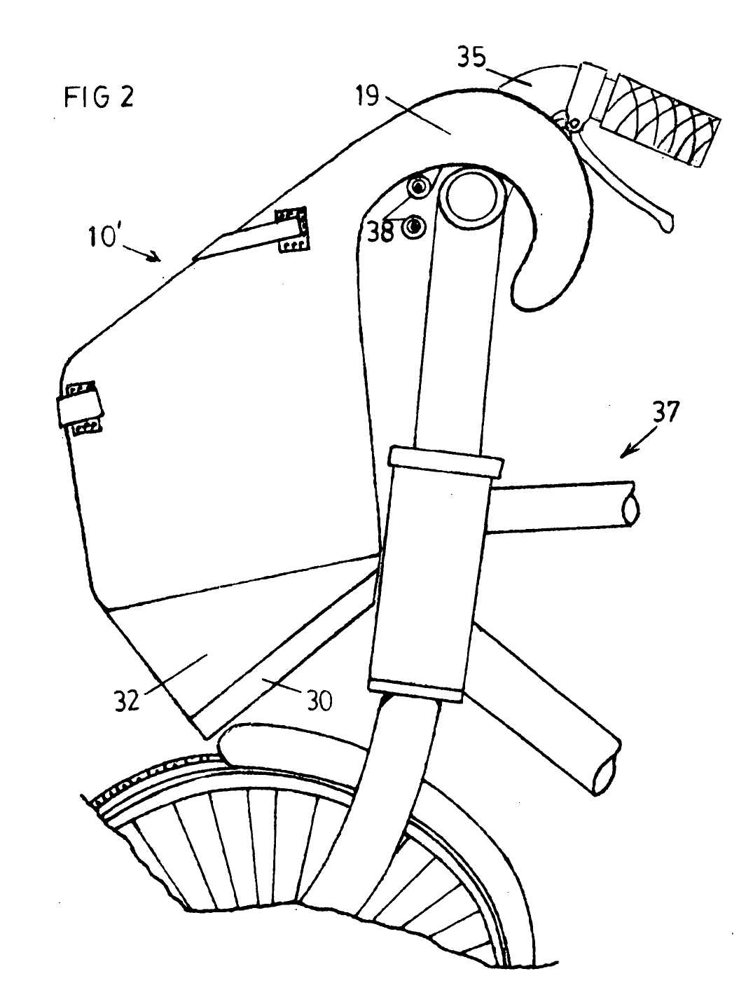

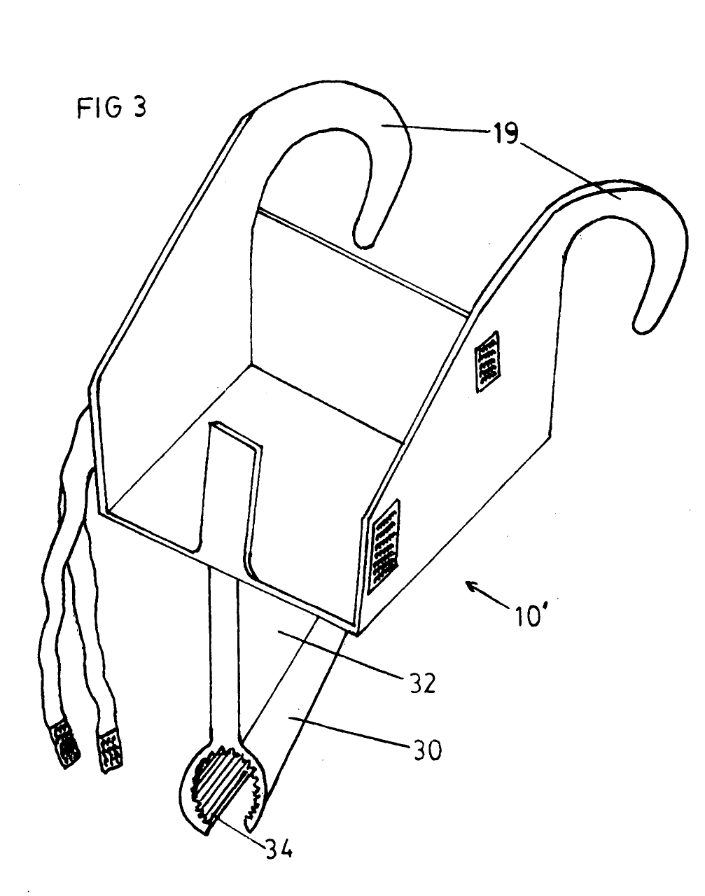

In the FIGS. 2 and 3 embodiment, a bifurcated mounting boss 30 depends beneath the seat portion 12 of the caddy 10′, by way of a tapered flange 32.

In FIG. 3 the boss 30 is shown having a series of spline teeth 34 about the inner surface thereof, enabling its use with a splmed shaft, as shown in my above referenced patent.

In FIG. 2, the toy caddy 10′ is mounted upon the handlebars 35 of a bicycle 37, of which bicycle 37 only a portion is shown. The near handlebar has been “cut away”, in order to better show the subject toy caddy 10′ in relation to the brake cables 38. In case of use of the toy caddy 10′ with a plain shaft or rod, such as a broomstick, the spline teeth 34 assist in stabilizing the caddy 10 upon such a supporting shaft, the bifurcation of the boss 30 providing a degree of resilience thereto.

The rearward taper of the flange 32 serves to orient the seat portion 12 in a substantially horizontal position when the supporting shaft is similarly inclined.

The boss 30 does not normally foul the structure of its conveyance.

It will be understood that the lateral stiffness of the caddy handle portions 19 will depend upon the type of plastic used, and upon the thickness of the handle section.

Alternative forms of handle other than substantially planar are contemplated.

1. A child's toy caddy for the transportation solely of a child's toy on a wheeled conveyance, the toy caddy consisting of a substantially miniscule seat, having a back portion and two side portions enclosing the sides and rear of the seat, and at least one handle portion extending rearwardly of the seat back portion to engage a laterally extending portion of a wheeled conveyance, to support the caddy in secured, positioned relation upon the conveyance, and enabling the safe transportation of said child's toy in the seat, on the conveyance.

2. The toy caddy as set forth in claim 1, including pommel means to facilitate retention of said toy by said seat.

3. The toy caddy as set forth in claim 1, including strap means removably secured across said seat, to facilitate retention of said toy by said caddy.

4. The toy caddy as set forth in claim 3, said caddy including hook and eye means associated with said strap means, enabling the securement of at least one strap across said seat in containing relation with said toy.

5. The toy caddy as set forth in claim 1, including a mounting boss for attaching the caddy to an elongated shaft.

6. The toy caddy as set forth in claim 5, said mounting boss being tapered, for attachment to an inclinable shaft, whereby said toy caddy seat portion may be readily positioned in a substantially horizontal orientation, to facilitate the retention of a child's toy thereon.

7. The toy caddy as set forth in claim 1, having two handle portions extending substantially coplanar with said caddy side portions, said handle portions being of laterally flexible construction and having a hook-like profile, to enable drop-over installation over the handlebars of a conveyance selected from the group consisting of tricycles, scooters and bicycles.

8. The toy caddy as set forth in claim 1, wherein said substantially miniscule seat is about five inches wide by four inches deep, to substantially preclude the use of said toy caddy by a human.
